(19) United States
(12) Patent Application Publication
(10) Pub. No.: US 2026/0296521 A1
(43) Pub. Date: Oct. 1, 2026

(54) STEERING WHEEL AND METHOD OF MANUFACTURING A STEERING WHEEL

(71) Applicant: TOYODA GOSEI CO., LTD., Kiyosu-shi (JP)

(72) Inventors: Kazuma MURAMATSU, Kiyosu-shi (JP); Akitoshi NAGANAWA, Kiyosu-shi (JP); Yuko SAKURAI, Kiyosu-shi (JP); Tsukasa KITAZAWA, Kiyosu-shi (JP); Masaaki MORI, Kiyosu-shi (JP)

(21) Appl. No.: 19/546,606

(22) Filed: Feb. 23, 2026

(30) Foreign Application Priority Data
Mar. 28, 2025 (JP) 2025-055131

(51) Int. Cl. B62D 1/06; B60Q 3/283

(52) U.S. Cl. CPC B62D 1/06; B60Q 3/283

(57) ABSTRACT

A steering wheel comprises a gripping portion gripped by a driver and a light emitting device assembled to the gripping portion. The light emitting device includes a substrate that has a light emitting element and has a substrate-side connector for relaying power supply wiring to the light emitting element. The substrate-side connector is electrically connected to the light emitting element. The gripping portion includes a gripping-side connector for relaying the power supply wiring. The gripping portion-side connector is connected to the substrate-side connector. A connecting direction between the substrate-side connector and the gripping portion-side connector aligns with an assembly direction of the substrate to the gripping portion.

### CROSS REFERENCE TO RELATED APPLICATIONS

The present application claims priority from Japanese patent application No. 2025-55131, filed Mar. 28, 2025, the disclosure of which is incorporated in its entirely by reference into the present application.

### BACKGROUND

### Field

The present disclosure relates to a steering wheel and a method of the steering wheel.

### Related Art

A steering wheel equipped with a device that emits light such as visible light or infrared light (hereinafter referred to as a “light emitting device”) in a position visible to the driver has been proposed (see, for example, JP2022-155656A). In the steering wheel described in JP2022-155656A, a substrate on which light emitting elements are provided is disposed of the gripping portion, and a power supply wiring and a substrate which are installed along the circumference direction within a gripping portion in advance are electrically connected to each other.

However, in the steering wheel described in JP2022-155656A, the wiring length at the tip of the power supply wiring where the connector is provided and where exposed in the recess on which the substrate is mounted at the grip portion is short. This short tip length results in poor workability when connecting the connector on the substrate to the connector on the power supply wiring. Therefore, a technique that can improve the workability of connecting the substrate of the light emitting device to the power supply wiring in the steering wheel is desired.

### SUMMARY

The present disclosure has been made to solve at least a part of the above problems. The present disclosure is feasible in the following aspects.

According to one aspect of the present disclosure, a steering wheel is provided. The steering wheel comprises a gripping portion gripped by a driver; and a light emitting device assembled to the gripping portion. The light emitting device may include a substrate having a light emitting element and having a substrate-side connector for relaying power supply wiring to the light emitting element, wherein the substrate-side connector is electrically connected to the light emitting element. The gripping portion may include a gripping portion-side connector for relaying the power supply wiring, wherein the gripping portion-side connector is connected to the substrate-side connector. A connecting direction between the substrate-side connector and the gripping portion-side connector may align with an assembly direction of the substrate to the gripping portion.

### BRIEF DESCRIPTION OF THE DRAWINGS

FIG. 1 is a plan view showing the external form of the steering wheel to which a light emitting device as an embodiment of the present disclosure is attached;

FIG. 2 is a plan view showing an external form of the steering wheel in a condition where the lens member is removed;

FIG. 3 is a first exploded perspective view showing a detail configuration of the illumination device;

FIG. 4 is a second exploded perspective view showing a detailed configuration of the illumination device;

FIG. 5 is a first cross-sectional view showing a cross section of the steering wheel;

FIG. 6 is a process diagram showing a process for manufacturing the steering wheel;

FIG. 7 is a divided perspective view showing a part of the steering wheel in the second embodiment;

FIG. 8 is a plan view showing a light emitting device in the third embodiment;

FIG. 9 is a first exploded perspective view showing a detailed configuration of the light emitting device in the third embodiment;

FIG. 10 is a second exploded perspective view showing a detailed configuration of the light emitting device;

FIG. 11 is a sectional view showing a cross section of a steering wheel according to the third embodiment; and

FIG. 12 is a process diagram showing a method of manufacturing the steering wheel in another embodiment.

### DETAILED DESCRIPTION

### A. First Embodiment:

A1. Overall configuration of a steering wheel 100:

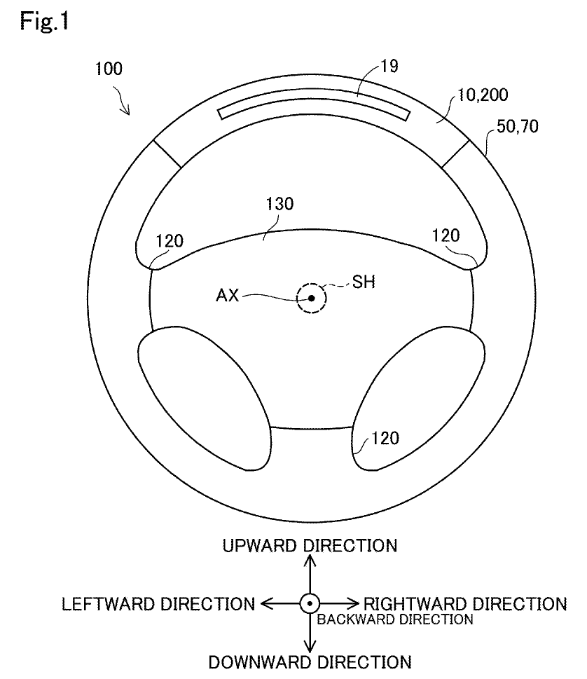

FIG. 1 is a plan view showing the external form of the steering wheel 100 to which a light emitting device 200 as an embodiment of the present disclosure is attached. The steering wheel 100 is located in the driver's seat of a vehicle and is used. Examples of vehicle include engine-equipped vehicle, hybrid vehicle (HEV), plug-in hybrid vehicle (PHEV), electric vehicle (BEV), and fuel-cell vehicle (FCV). The steering wheel 100 is part of a steering device operated by the driver of the vehicle. FIG. 1, represents the steering wheel 100 in the condition where the steering wheel 100 is connected to as steering shaft SH in the vehicle and where the vehicle moves straight (hereinafter, referred to as "reference condition"). FIG. 1 further represents the external configuration of a side facing the driver in the steering wheel 100 (rear direction side described later). The steering wheel 100 is configured to be rotatable about an axis AX of the steering shaft SH. The revolution of the steering wheel 100 is transmitted to a steering gearbox (not shown) via the steering shaft SH.

In the present embodiment, the direction along the axis AX of the steering shaft SH is referred to as a "front-rear direction" (front direction and rear direction) in association with the traveling direction of vehicles. Among the directions perpendicular to the axis AX, the direction overlapping with the vertical direction (vertical upward and vertical downward) as viewed from the driver is called the "vertical direction". Among the directions perpendicular to the axis AX, the direction parallel to the lateral direction (width direction) of vehicles is referred to as the "lateral direction."

The steering wheel 100 comprises a ring-shaped gripping portion 50, a boss portion 130, three spoke portions 120, and an illumination device 200. The boss portion 130 is located generally at the center of gripping portion 50. The illumination device 200 is disposed of a portion of the gripping portion 50.

The gripping portion 50 is gripped by the driver when the steering wheel 100 is operated. In the present embodiment, the shape of the gripping portion 50 is substantially annular shape. The central axis of the gripping portion 50 aligns with the axis AX of the steering shaft SH. The shape of the gripping portion 50, instead of the substantially annular shape, may be any shape such as a polygonal shape or an elliptical shape, also may be an asymmetrical shape such as a so-called D-shape. Furthermore, the shape of the gripping portion 50 is not limited to an annular, it may be any shape formed by a plurality of parts provided at a position apart from each other. As described below, the gripping portion 50 is configured that a plurality of members is superimposed in the thickness direction. The outermost layers are formed by an outer layer (an outer layer 80 described later) formed by the leather member. Although not shown in FIG. 1, a recess portion (a first recess portion C1 to be described later) is formed on a portion of the upper part of the gripping portion 50 in the reference condition of the gripping portion 50. In the first recess portion C1, a portion of the illumination device 200 is housed. The opening of the first recess portion C1 is closed by the illumination device 200.

Three spoke portions 120 couple the gripping portion 50 and the boss portion 130. The boss portion 130 corresponds to the connecting point where the steering wheel 100 is connected to the steering shaft SH. The interior of the boss portion 130 houses a folded airbag and inflator, both not shown. The interior of the boss portion 130 further houses a temperature control circuitry constituting the heaters device, or various sensors for detecting a room temperature or a grip of the gripping portion 50 by user. The three spoke portions 120 and the boss portion 130 may be provided with various operating buttons for operating a navigation device or an audio device mounted on the vehicle.

The light emitting device is mounted on the gripping portion 50. The illumination device 200 emits light. In the present embodiment, the light emitted by the illumination device 200 is visible light. By emitting visible light from the illumination device 200, various information can be informed to the driver. For example, it is possible to notify some information to the driver by emitting visible lights of various colors or by emitting a blinking light. Specifically, by emitting red light, it is possible to urge the driver to grasp the steering wheel 100.

A2. Detailed configuration of the light emitting device 200:

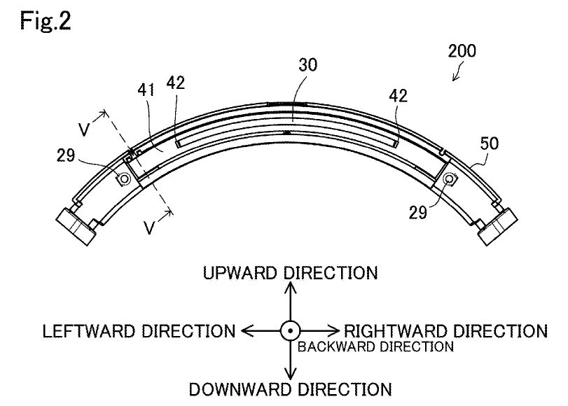

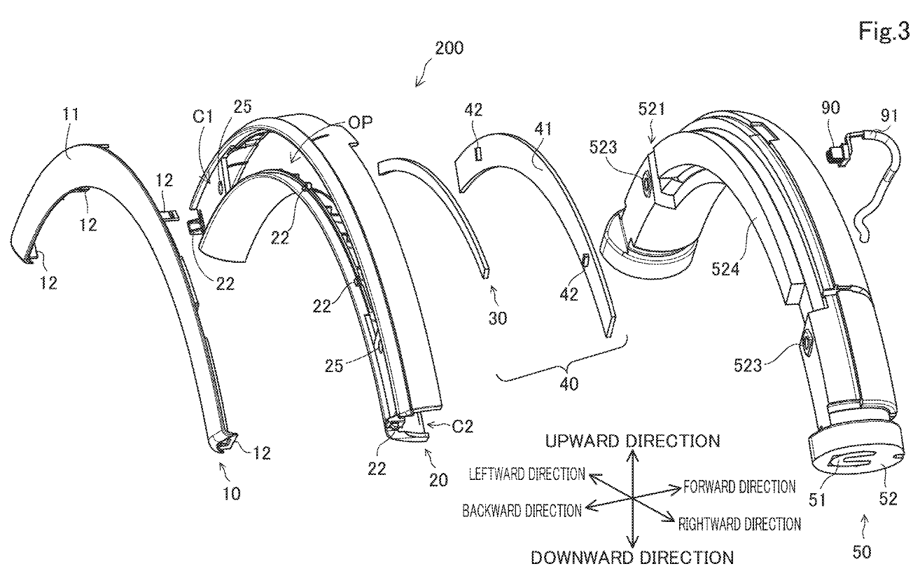

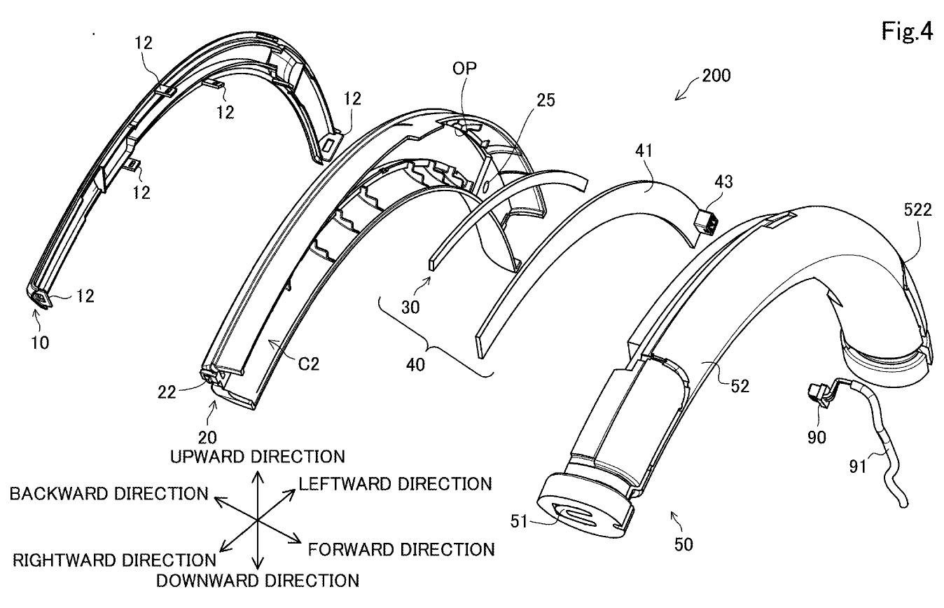

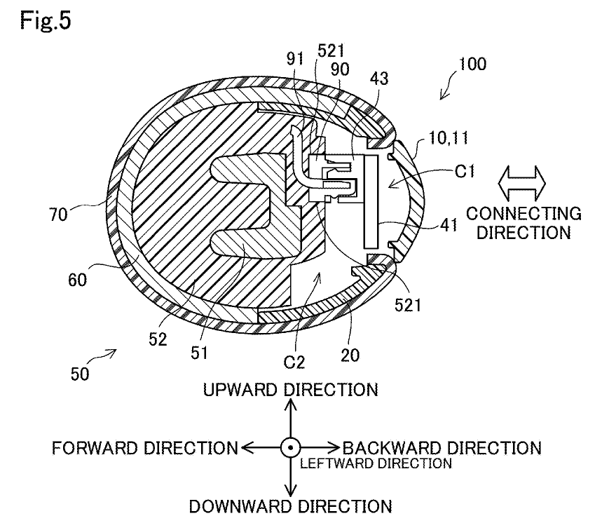

FIG. 2 is a plan view showing an external form of the steering wheel 100 in a condition where the lens member 10 is removed. FIG. 3 is a first exploded perspective view showing a detail configuration of the illumination device 200. FIG. 4 is a second exploded perspective view showing a detailed configuration of the illumination device 200. FIG. 5 is a first cross-sectional view showing a cross section of the steering wheel 100. In addition to the light emitting device 200, a portion of the gripping portion 50 to which the light emitting device 200 is assembled is also shown in FIGS. 2 to 4. FIG. 2 shows the light emitting device 200 with the lens member 10 to be described later removed. FIG. 3 corresponds to an exploded perspective view of the light emitting device 200 from approximately the rear side toward the front side. FIG. 4 corresponds to an exploded perspective view of the light emitting device 200 from approximately the front side toward the rear side. FIG. 5 shows V-V cross section shown in FIG. 2.

As shown in FIGS. 2 - 5, the light emitting device 200 includes a lens member 10, a base member 20, and a light emitting portion 40.

As shown in FIGS. 1 and 5, the lens member 10 forms part of the outer surface of the steering wheel 100. The lens member 10 is transparent to visible light and outputs visible light to the outside of the steering wheel 100. As shown in FIGS. 3 and 4, the lens member 10 includes an outer surface forming portion 11 and a plurality of engaging wall 12.

The outer surface forming portion 11, as viewed from the driver, has a curved arc and strip-shaped external form along the circumferential direction of the gripping portion 50 (hereinafter, simply referred to as "circumferential direction"). In the following, the radial direction of the gripping portion 50 (direction perpendicular to the axis AX) is simply referred to as a "radial direction". The outer surface forming portion 11 is transparent to visible light. The outer surface forming portion 11 outputs the visible light from the light emitting portion 40 to the vehicle interior. As shown in FIG. 1, the outer surface forming portion 11 has an emitting region 19. Emitting region 19 has higher transmittance of visible light compared to other regions. In the present embodiment, the transmittance of visible light in the emitting region 19 is approximately 25%, the transmittance of visible light in other regions is 10% or less. Therefore, it can be said that the outer surface forming portion 11 has a function of limiting an area which transmits visible light. The outer surface forming portion 11 is formed of a black transparent synthetic resin, for example, a polycarbonate (PC) resin in accordance with a black outer layer 70. Note that the transmittance of visible light in the emitting region 19 and other regions is merely an example and may be any value. In addition, the material of the outer surface forming portion 11 may be any material such as an acrylic resin instead of a PC resin.

As shown in FIGS. 3 and 4, the plurality of the engaging wall 12 are spaced apart from each other along the outer edge of the lens member 10. Each engaging wall 12 is disposed to protrude forward. The engagement hole that engages claw 22 (to be described later) when the lens member 10 is fitted into the base member 20 is provided.

The base member 20 serves as a housing for the light emitting device 200. The base member 20 holds the lens member 10. The base member 20 houses the light emitting portion 40. As shown in FIGS. 3 and 4, the base member 20 has an arc-shaped and strip-shaped external form curved along the circumferential direction, as viewed from the driver. In this embodiment, the base member 20 is formed of an ABS resin As shown in FIG. 3, on the rear of the base member 20, the first recess portion C1 is provided. The first recess portion C1 opens backward. The recess C1, the outer surface forming portion 11 is accommodated in the first recess. The depth of the first recess portion C1 (longitudinal dimension) aligns with the thickness of the outer surface forming portion 11. As shown in FIG. 4, in the forward direction of base member 20, the second recess portion C2 is provided which is open in the forward direction. The second recess portion C2 houses the light emitting portion 40. A through hole OP is formed in the center of the base member 20, as viewed from the driver. The shape of the through hole OP when viewed in plan is an arc-shaped shape. A portion of the rear side of the light emitting portion 40 housed in the second recess C2 is inserted into the through hole OP. Therefore, the light emitting portion 40 faces the lens member 10 in the longitudinal direction. In base member 20, the engaging claw 12 is provided at the position corresponding to the respective the engaging wall 12 described above in the front-rear direction. In the base member 20, the screw hole 25 is provided in the circumferential end portions.

The light emitting portion 40 comprises a substrate 41, a pair of light emitting element 42, a substrate-side connector 43 and a light guiding member 30.

The substrate 41, as viewed from the driver, has a curved arc-shaped and strip-shaped external form along the circumferential direction. The pair of light emitting element 42, in the rear direction of the surface of the substrate 41 (also referred to as "the front surface") are respectively disposed of the left and right ends in the circumferential direction. Each light emitting element 42 emits visible light in a direction such as along the circumferential direction toward the other the light emitting element 42. In the present embodiment, the light emitting element 42 is constituted by LED (Light Emitting Diode) that can output a red light and green light and blue light.

The substrate-side connector 43 is electrically connected to the light emitting element 42 via a wire (not shown) which is provided on the front surface of the substrate 41 and the inside of the substrate 41. The substrate-side connector 43 relays power supply wiring to the light emitting element. "Power supply wiring" refers to the combined concepts of wires (not shown) provided on or within the front face of the substrate 41 described above and the harness 91 to be described later. As shown in FIG. 4, the substrate-side connector 43 is provided at the end portion in the leftward direction on the front side surface of the substrate 41 (also referred to as "the back surface"). The substrate-side connector 43 is a so-called female connector. The substrate-side connector 43 is opened in the forward direction.

The light guiding member 30 guides the visible light emitted by the light emitting element 42 to the lens member 10. In this embodiment, the light guiding member 30 is formed of a PC resin. In place of PC resin, it may be formed of an acrylic resin. The light guiding member 30 has an arcuate and band-like external form curved along the circumferential direction, as viewed from the driver. The light guiding member 30 is disposed between the pair of light emitting element 42. The light guiding member 30 is fixed by a claw or the like (not shown) with respect to the substrate 41. Right and left end surfaces in the circumferential direction of the light guiding member 30 is opposed to the output surface of the visible light in a pair of light emitting element 42. Visible light output from each light emitting element 42 is scattered circumferentially in the light guiding member 30, while repeating the reflections. Further, at a substrate 41-side surface of the light guiding member 30 (front side surface), a number of grooves (not shown) for directing the visible light to the rear direction is formed. Therefore, the visible light from the rear-side end surface of the light guiding member 30 is output toward the lens member 10.

A3. Detailed configuration of the gripping portion 50:

In the gripping portion 50, the cross-sectional configuration of the other portions except for the portion where the light emitting device 200 is mounted is different from the cross-sectional configuration of the portion where the light emitting device 200 is mounted shown in FIG. 5 in that the light emitting device 200 is not mounted, the other configurations are the same.

As shown in FIG. 5, the gripping portion 50 includes a core metal 51, a core portion 52, an element layer 60, an outer layer 70, a gripping portion-side connector 90, and a harness 91.

The core metal 51 is made of metal. The core metal 51 is a member which becomes a skeleton of the gripping portion 50 In the present embodiment, the core metal 51 is formed of aluminum-alloy. Instead of an aluminum alloy, the core metal 51 may formed of any type of metal such as a magnesium alloy or steel. The core metal 51 has an annular-shaped external form. As shown in FIG. 3, the core portion 52 comprises a substrate mounting portion 524 at the location where the light emitting device 200 is to be assembled. The substrate mounting portion 524 is not covered by the outer layer 70 and faces the light emitting portion 40. The rearward end face of the substrate mounting portion 524 is formed in a plane. At the substrate mounting portion 524, the front side surface of the substrate 41 is disposed in contact. The substrate 41 is fixed by screws (not shown) with respect to the substrate mounting portion 524.

The core portion 52 is arranged to cover the entire the core metal 51. The core portion 52 forms the core of the gripping portion 50. The core portion 52 is formed of a soft synthetic resin having a cushioning property which functions as an impact absorbing material. Specifically, in this embodiment, the core portion 52 is formed of a soft foam material such as foamed polyurethane. As shown in FIGS. 2 and 5, at the core portion 52, the connector fixing portion 521 is formed. The connector fixing portion 521 is formed as a trench to accommodate the gripping portion-side connector 90. The connector fixing portion 521 secures the gripping portion-side connector 90 in a rearward-facing state. The "the gripping portion-side connector 90 is in a rearward-facing state" means that the posture of the gripping portion-side connector 90 is a posture where the gripping portion-side connector 90 can be connected by moving in the forward direction relative to the substrate-side connector 43 which will be described later. As shown in FIG. 4, the receiving groove 522 is formed in the core portion 52. The receiving groove 522 houses the harness 91. The receiving groove 522 is continuously provided in the core portion 52 from the connecting portion to the spoke portion 120 to the portion to which the light emitting device 200 is assembled. As shown in FIG. 3, the screw hole 523 is formed in the core portion 52.

The element layer 60 partially covers the core portion 52. The element layer 60 is a layer to which a heating wire that constitutes a heater device or a wire for detecting gripping is provided. For example, the element layer 60 is formed by a conductive cloth obtained by performing a surface treatment such as carbon coating or metal plating on a textile cloth.

The outer layer 70 continuously covers the outer surface of the element layer 60 and the outer surface of the rearward-facing end of the base member 20. As shown in FIG. 5, the terminal portion of the leather member constituting the outer layer 70 is housed in the first recess portion C1. The outer layer 70 is formed of a leather member. In the present embodiment, the leather member is composed of natural leather such as a top leather or a split leather divided from the top leather. Note that the leather member may be made of any kind of leather material, such as synthetic leather or artificial leather, instead of natural leather.

The gripping portion-side connector 90 is a connector for relaying the above-described power supply wiring. The gripping portion-side connector 90 is provided at the end of harness 91. The gripping portion-side connector 90 is a so-called male connector. The gripping portion-side connector 90 is fixed to the connector fixing portion 521 of the core portion 52 in a direction in which the terminal protrudes rearward. When the light emitting device 200 is assembled to the gripping portion 50 (hereinafter referred to as "assembled state"), the substrate-side connector 43 and the gripping portion-side connector 90 are connected to each other. "Connecting" means that, in the present embodiment, both connectors 43 and 90 are fitted to each other and the terminals each have are in contact and electrically connected to each other. As shown in FIG. 5, the connecting direction between the substrate-side connector 43 and the gripping portion-side connector 90 is the front-rear direction. "The connecting direction" is the direction in which both connectors 43 and 90 are attached or detached.

The harness 91 includes a wire for providing power to a pair of light emitting element 42. Note that in FIGS. 3 and 4, for convenience of illustration, it shows only a portion of the harness 91. At one end of the harness 91, the gripping portion-side connector 90 is provided. The harness 91 is housed in the above-described the receiving groove 522 provided in the core portion 52. Accordingly, the harness 91 is disposed from the part where the light emitting device 200 is assembled to the spoke portion 120, and passes through the spoke portion 120 to the boss portion 130. The boss portion 130 has the harness connectors (not shown) arranged along the steering shaft SH. In harness 91, at the opposite side end which is opposite to the end on which the gripping portion-side connector 90 is provided, a connector for connecting with the above-described connector disposed in the spoke portion 120 is provided.

A4. Method of manufacturing the steering wheel 100:

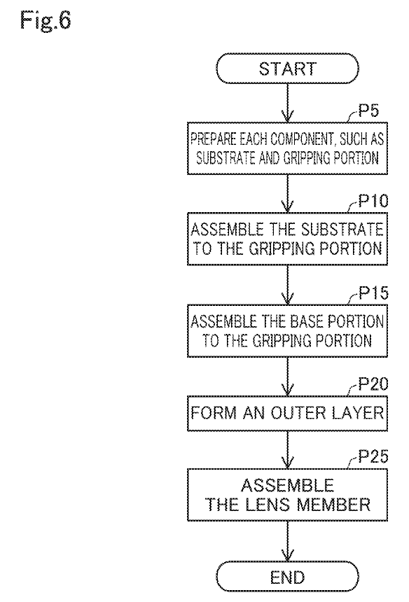

FIG. 6 is a process diagram showing a process for manufacturing the steering wheel 100. In process P5, the components of the steering wheel 100 are prepared. For example, as the light emitting device 200, a light emitting device 200 having a substrate on which the substrate-side connector 43 and a pair of light emitting elements 42 are provided is prepared. The gripping portion 50 having the gripping portion-side connector 90 is also prepared. In preparing the gripping portion 50, the harness 91 is accommodated and fixed in a receiving groove 522 of the core portion 52 and the gripping portion-side connector 90 is accommodated and fixed in the connector fixing portion 521 of the gripping portion 50.

In process P10, the substrate 41 is assembled to the gripping portion 50. In this process, the light emitting portion 40 is assembled to the gripping portion 50 such that the light emitting portion 40 is moved forward relative to the gripping portion 50 and the substrate-side connector 43 is inserted with the gripping portion-side connector 90. The direction in which the light emitting portion 40 (the substrate 41) is assembled to the gripping portion 50 (hereinafter referred to as "assembly direction") aligns the connecting direction of the substrate-side connector 43 and the gripping portion-side connector 90. Therefore, it can be said that the process P10 is "a process of connecting the substrate-side connector 43 and the gripping portion-side connector 90 by assembling the substrate 41 to the gripping portion 50 while aligning the assembly direction with the connecting direction of the substrate-side connector 43 and the gripping portion-side connector 90."

In process P15, the base member 20 is assembled to the gripping portion 50. In this process, so that the light emitting portion 40 is inserted into the through hole OP of base member 20, the base member 20 is aligned with the gripping portion 50. Then, the screw 29 shown in FIG. 2, is inserted over the screw hole 25 of the light emitting device 200 and the screw hole 523 of the gripping portion 50 by screwed the screw threads provided in the core metal 51, the base member 20 is fixed to the gripping portion 50.

In process P20, an outer layer 70 is formed. In process P25, the lens member 10 is assembled to the base member 20. In this process, the lens member 10 is pressed forward with respect to the base member 20, the outer surface forming portion 11 is accommodated in the first recess portion C1, the engaging wall 12 and the engaging claw 22 is engaged. Completion of the process P25 completes the steering wheel 100.

According to the steering wheel 100 of the first embodiment described above, the connecting direction between the substrate-side connector 43 and the gripping portion-side connector 90 aligns with the assembly direction of the substrate 41 to the gripping portion 50. Therefore, by assembling the substrate 41 to the gripping portion 50, the substrate-side connector 43 and the gripping portion-side connector 90 can be connected to each other. Therefore, the workability of connecting the substrate 41 and the power supply wiring can be improved with the steering wheel 100.

The connecting direction between the substrate-side connector 43 and the gripping portion-side connector 90 is parallel to the rotation axis AX of the steering wheel. Therefore, by assembling the substrate 41 to the gripping portion 50 along the direction parallel to the axis AX, or the forward direction, the substrate 41 and the power supply wiring can be connected to each other.

The gripping portion 50 comprises the harness 91 which has one end connected to the gripping portion-side connector 90 and which is a part of the power supply wiring, and the connector fixing portion 521 for fixing the gripping portion-side connector 90. Therefore, prior to assembly operation, with respect to the gripping portion 50, the power supply wiring and the gripping portion-side connector 90 can be fixed in advance. Therefore, it is possible to easily connect the substrate-side connector 43 and the gripping portion-side connector 90 during assembly.

The substrate-side connector 43 is provided on the back surface of the substrate 41, so that compared to the configuration that the substrate-side connector is provided on the front surface of the substrate 41, the wire length of the power supply wiring up to the substrate-side connector 43 can be shortened. In addition, since the light emitting element 42 and the substrate-side connector 43 are provided on the different sides of the front surface and the back surface of the substrate 41, the gripping portion-side connector 90 and the light emitting element 42 can be suppressed from contacting each other in the assembly operation. Therefore, it is possible to suppress the damages of the light emitting element 42 and the gripping portion-side connector 90.

In addition, according to the method of manufacturing the steering wheel 100 of the first embodiment, the method comprises a process of assembling the substrate 41 to the gripping portion 50, and the substrate-side connector 43 and the gripping portion-side connector 90 are connected by aligning an assembly direction of the substrate 41 to the gripping portion 50 with a connecting direction between the substrate-side connector 43 and the gripping portion-side connector 90. Therefore, it is possible to improve the workability of the connecting operation of the substrate 41 and the power supply wiring in the steering wheel 100.

### B. Second Embodiment:

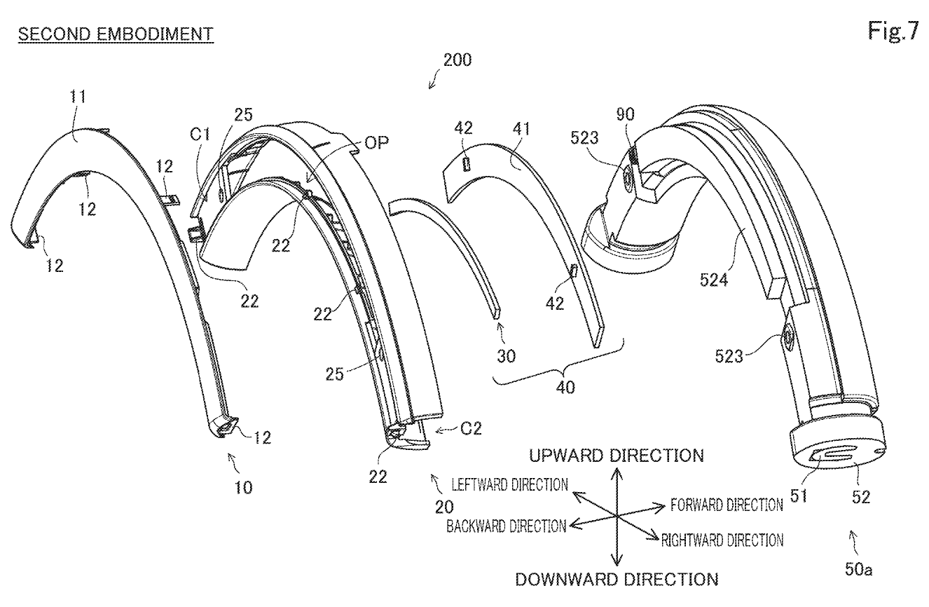

FIG. 7 is a divided perspective view showing a part of the steering wheel 100 in the second embodiment. FIGS. 7, like 3, shows an exploded perspective view of the light emitting device 200 and the gripping portion 50a constituting a part of the steering wheel 100. The steering wheel 100 of the second embodiment differs from the steering wheel 100 of the first embodiment in that it comprises a gripping portion 50a in place of the gripping portion 50. The same components as those of the steering wheel 100 of the first embodiment in the steering wheel 100 of the second embodiment are denoted by the same reference numerals, and a detailed explanation thereof will be omitted.

The gripping portion 50a differs from the gripping portion 50 of the first embodiment in that the gripping portion-side connector 90 and the harness 91 and the core portion 52 are integrally manufactured by insert-molding, and the other configurations are the same. Specifically, the core metal 51 and the harness 91 in which the gripping portion-side connector 90 is provided are accommodated in the mold for forming the core portion 52 in advance, then by injecting a resin material into the mold, the gripping portion 50a is formed.

The steering wheel 100 of the second embodiment having the above configuration has the same advantages as the steering wheel 100 of the first embodiment. In addition, since the gripping portion-side connector 90 and the harness 91 and the core portion 52 are integrally manufactured by insert-molding, the step of placing the harness 91 along the face of the core portion 52 (the receiving groove 522) can be omitted.

### C. Third Embodiment:

C1. Device Configuration :

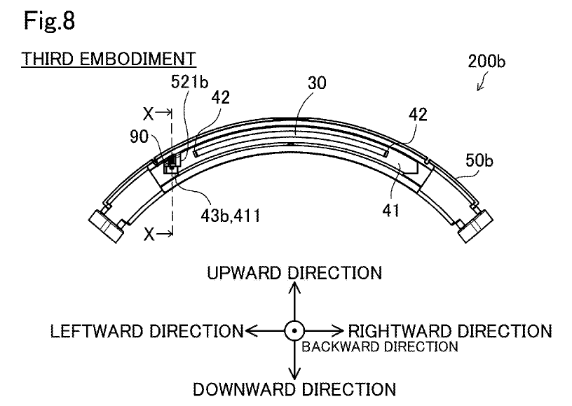

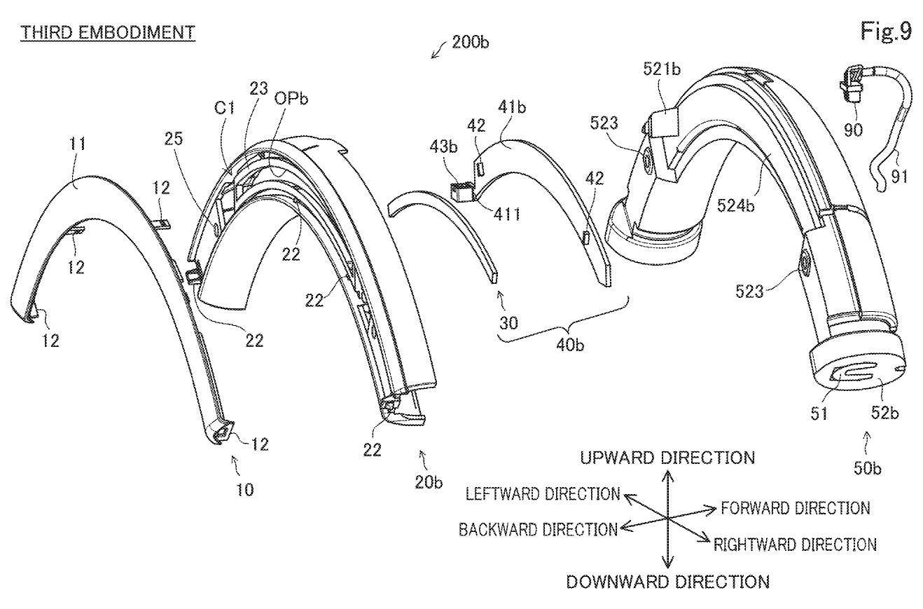

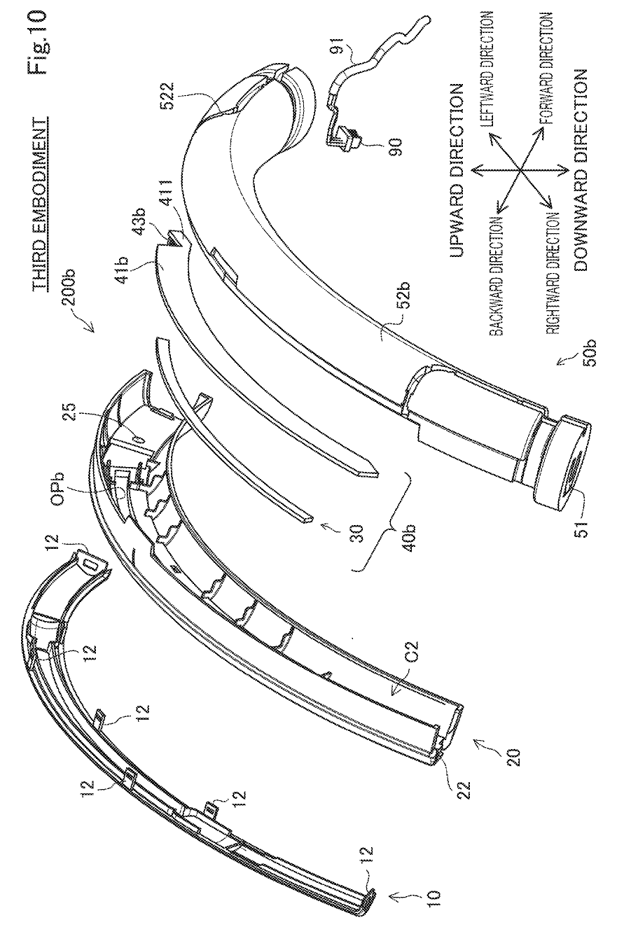

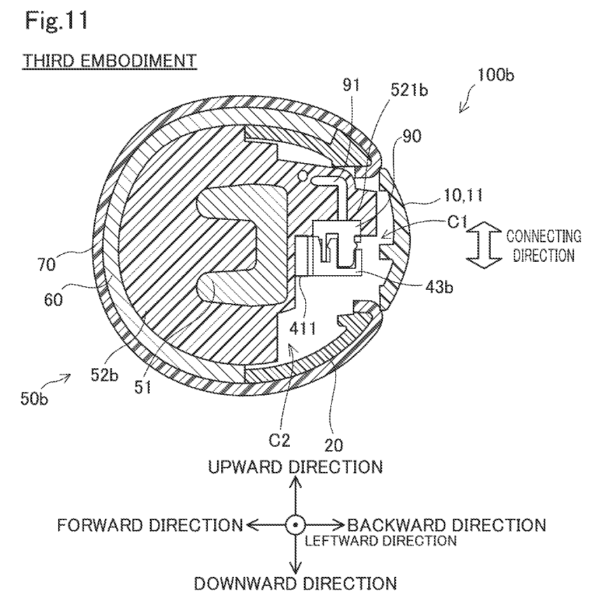

FIG. 8 is a plan view showing a light emitting device 200b in the third embodiment. FIG. 9 is a first exploded perspective view showing a detailed configuration of the light emitting device 200b in the third embodiment. FIG. 10 is a second exploded perspective view showing a detailed configuration of the light emitting device 200b. FIG. 11 is a sectional view showing a cross section of a steering wheel 100b according to the third embodiment.

The steering wheel 100b of the third embodiment differs from the steering wheel 100 of the first embodiment in that a light emitting device 200b is provided instead of the light emitting device 200 and a gripping portion 50b is provided instead of the gripping portion 50, and the other configurations are the same. The same components as those of the steering wheel 100 of the first embodiment in the steering wheel 100b of the third embodiment are denoted by the same reference numerals, and a detailed explanation thereof will be omitted.

The light emitting device 200b of the third embodiment differs from the light emitting device 200 of the first embodiment in that it includes a base member 20b in place of the base member 20 and a light emitting portion 40b in place of the light emitting portion 40, and other configurations are the same.

The base member 20b differs from the base member 20 of the first embodiment in that a protrusion portion 23 is provided in place of the through hole OP in the first recess portion C1. Protrusion portion 23, as viewed from the driver, has a curved arc-shaped and strip-shaped external form along the circumferential direction. The protrusion portion 23 protrudes rearward in the first recess portion C1. In the protrusion portion 23, through hole OPb is formed at the rear end surface. This through hole OPb also has an arc-shaped and strip-shaped external form curved along the circumferential direction, as viewed from the driver. The through hole OPb is also shaped and sized to precisely accommodate the light guiding member 30 when viewed back and forth.

The light emitting portion 40b differs from the light emitting portion 40 of the first embodiment in that it includes a substrate 41b in place of the substrate 41 and a substrate-side connector 43b in place of the substrate-side connector 43, and other configurations are the same. The substrate 41b differs from the substrate 41 of the first embodiment in that it comprises an outwardly projecting a protrusion 411 along the circumferential direction at the left end.

In a third embodiment, the substrate-side connector 43b is provided in the protrusion 411 in the substrate 41b. Further, unlike the first embodiment, the substrate-side connector 43b is disposed on the front surface of the substrate 41b (frontward surface), also is open upward.

The gripping portion 50b differs from the gripping portion 50 of the first embodiment in that it comprises a core portion 52b in place of the core portion 52, and the other configurations are the same. The core portion 52b differs from the core portion 52 of the first embodiment in that it includes a substrate mounting portion 524b in place of the substrate mounting portion 524 and a connector fixing portion 521b in place of the connector fixing portion 521, the other configurations are the same. As shown in FIG. 9, the substrate mounting portion 524b has a thickness (longitudinal dimension) formed smaller than the thickness of the substrate mounting portion 524 of the first embodiment. The connector fixing portion 521b is provided to protrude rearward at the end portion in the left direction in the substrate mounting portion 524b. The connector fixing portion 521b secures the gripping portion-side connector 90 in a facing downward state. "The gripping portion-side connector 90 is in a facing downward state" means that the posture of the gripping portion-side connector 90 is a posture where the substrate-side connector 43b is mounted by moving downward relative to the substrate-side connector 43b.

C2. Method of Manufacturing the Steering wheel 100b:

The method of manufacturing the steering wheel 100b of the third embodiment is the same as the method of manufacturing of the first embodiment shown in FIG. 6, except that the detailed procedure of assembling the substrate 41b to the gripping portion 50b in process P10 differs slightly.

In process P10, the light emitting portion 40b (the substrate 41b) is assembled to the gripping portion 50b so that the light emitting portion 40b is moved forward with respect to the gripping portion 50b and then the light emitting portion 40b is moved upward with respect to the gripping portion 50b. This upward movement of the light emitting portion 40b connects the substrate-side connector 43b with the gripping portion-side connector 90. Therefore, even in the third embodiment, the upward direction of, or an assembly direction, where the light emitting portion 40b (the substrate 41b) to be assembled to the gripping portion 50b aligns the connecting direction between the substrate-side connector 43b and the gripping portion-side connector 90.

The steering wheel 100b of the third embodiment described above has the same advantages as the steering wheel 100 of the first embodiment.

### D. Other Embodiments:

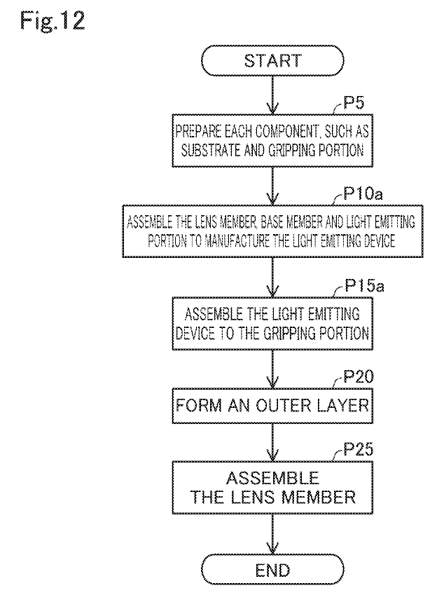

(D1) The procedure of the method of manufacturing the steering wheel 100 of the first embodiment and the second embodiment may be changed. FIG. 12 is a process diagram showing a method of manufacturing the steering wheel 100 in another embodiment.

The method of manufacturing the steering wheel 100 according to other embodiment differs from the method of manufacturing the steering wheel 100 according to the first embodiment shown in P10 in that a process P10a is performed in place of a process P10 and a process P15a is performed in place of a process P15, and the other processes are the same. In process P10a, the lens member 10, the base member 20, and the light emitting portion 40 are assembled in together to manufacture the light emitting device 200. In this process, the light emitting portion 40 may be fixed to the lens member 10 by screws (not shown).

In process P15a, the light emitting device 200 is assembled to the gripping portion 50. In this process, the light emitting device 200 is brought closer to the frontward with respect to the gripping portion 50 and then the light emitting device 200 is assembled to the gripping portion 50 so that the gripping portion-side connector 90 is inserted in the substrate-side connector 43. Therefore, even in this configuration, the direction where the substrate 41 is assembled to the gripping portion 50 (the assembly direction) aligns the connecting direction of the substrate-side connector 43 and the gripping portion-side connector 90.

In such a configuration, the light emitting device 200 and the gripping portion 50 may be fixed by snap-fit or the like to each other. Further, in such a configuration, the outer layer 70 may be made of a leather material having a light-transmitting property. This allows the outer surface forming portion 11 to emit light to the outside even if the outer layer 70 is formed by wrapping the leather material around the gripping portion 50 on which the light emitting device 200 is mounted.

The methods of manufacturing may be changed differently from FIG. 12. For example, the base member 20 and the light emitting portion 40 may be assembled in advance, the assembly in which the base member 20 and the light emitting portion 40 are assembled is assembled to the gripping portion 50, the outer layer is formed in this condition, and finally the lens member 10 is fitted into the first recess portion C1.

(D2) In the first embodiment, in process P10, the light-emitting portion 40 is assembled to the gripping portion 50 such that the light-emitting portion is moved forward to the gripping portion 50 and the gripping portion-side connector 90 is inserted into the substrate-side connector 43, but the present disclosure is not limited thereto. The gripping portion 50 may be assembled to the light emitting portion 40 such that the gripping portion 50 is moved backward to the light emitting portion 40 and the gripping portion-side connector 90 is inserted into the substrate-side connector 43. Similarly, in the third embodiment, when the substrate 41b is assembled to the gripping portion 50b, the light emitting portion 40b is moved forward to the gripping portion 50b, and then the light emitting portion 40b is moved upward with respect to the gripping portion 50b, but the present disclosure is not limited thereto. The gripping portion 50b may be moved backward to the light emitting portion 40b, and then the gripping portion 50b may be moved downward relative to the light emitting portion 40b. Also in these configurations, it is possible to achieve the effects of the embodiments.

(D3) In the first and second embodiments, the assembly direction, and the connecting direction between the substrate-side connector 43 and the gripping portion-side connector 90 were both front-rear direction. In the third embodiment, the assembly direction, and the connecting direction between the substrate-side connector 43 and the gripping portion-side connector 90 were both vertical directions. The present disclosure is not limited to these. The assembly direction, and the connecting direction between the substrate-side connector 43 and the gripping portion-side connector 90 may be any direction without being limited to the vertical direction and the front-rear direction, as long as they align with each other.

The present disclosure is not limited to each of the embodiments described above and is able to be realized with various configurations without departing from the spirit thereof. For example, technical features in the embodiments corresponding to the technical features in the aspect described in the section of SUMMARY are able to be replaced with each other or combined together, as appropriate, in order to solve part or the whole of the problems described previously or to achieve part or the whole of the effects described previously. When the technical features are not described as essential features in the present specification, they are able to be deleted, as appropriate. For example, the present disclosure may be realized in aspects described below.

(1) According to one aspect of the present disclosure, a steering wheel is provided. The steering wheel comprises a gripping portion gripped by a driver; and a light emitting device assembled to the gripping portion. The light emitting device may include a substrate having a light emitting element and having a substrate-side connector for relaying power supply wiring to the light emitting element, wherein the substrate-side connector is electrically connected to the light emitting element. The gripping portion may include a gripping portion-side connector for relaying the power supply wiring, wherein the gripping portion-side connector is connected to the substrate-side connector. A connecting direction between the substrate-side connector and the gripping portion-side connector may align with an assembly direction of the substrate to the gripping portion.

According to the steering wheel of this aspect, the connecting direction between the substrate-side connector and the gripping portion-side connector aligns with the assembly direction of the substrate to the gripping portion. Therefore, by assembling the substrate to the gripping portion, the substrate-side connector and the gripping portion-side connector can be connected to each other. Therefore, the workability of connecting the substrate and the power supply wiring can be improved in the steering wheel.

(2) In the steering wheel of the above aspect, the connecting direction may be parallel to a rotation axis of the steering wheel.

According to the steering wheel of this aspect, the connecting direction between the substrate-side connector and the gripping portion-side connector is parallel to the rotation axis AX of the steering wheel. Therefore, by assembling the substrate to the gripping portion along the direction parallel to the axis, the substrate and the power supply wiring can be connected to each other.

(3) In the steering wheel of the above aspect, the gripping portion may further include a harness as a part of the power supply wiring. The harness may have one end connected to the gripping portion-side connector; and a fixing portion for fixing the gripping portion-side connector.

The gripping portion further comprises the harness which has one end connected to the gripping portion-side connector and which is a part of the power supply wiring, and the connector fixing portion for fixing the gripping portion-side connector. Therefore, prior to assembly operation, with respect to the gripping portion, the power supply wiring and the gripping portion-side connector can be fixed in advance. Therefore, it is possible to easily connect the substrate-side connector and the gripping portion-side connector during assembly.

(4) In the steering wheel of the above aspect, the light emitting element may be provided on a front surface of the substrate. The substrate-side connector may be provided on a back surface of the substrate.

The substrate-side connector is provided on the back surface of the substrate, so that compared to the configuration that the substrate-side connector is provided on the front surface of the substrate, the wire length of the power supply wiring up to the substrate-side connector can be shortened. In addition, since the light emitting element and the substrate-side connector are provided on the different sides of the front surface and the back surface of the substrate, the gripping portion-side connector and the light emitting element can be suppressed from contacting each other in the assembly operation. Therefore, it is possible to suppress the damages of the light emitting element and the gripping portion-side connector.

(5) According to another aspect of the present disclosure, a method of manufacturing a steering wheel having a gripping portion gripped by a driver and a light emitting device assembled to the gripping portion. The method may comprise preparing, as the light emitting device, a light emitting device that includes a substrate having a light emitting element and having a substrate-side connector for relaying power supply wiring to the light emitting element, the substrate-side connector being electrically connected to the light emitting element; preparing, as the gripping portion, a gripping portion that includes a gripping portion-side connector for relaying the power supply wiring, the gripping portion-side connector being connected to the substrate-side connector; and assembling the substrate to the gripping portion. The substrate-side connector and the gripping portion-side connector are connected by aligning an assembly direction of the substrate to the gripping portion with a connecting direction between the substrate-side connector and the gripping portion-side connector.

According to the method of manufacturing the steering wheel of this aspect, the method comprises assembling the substrate to the gripping portion. The substrate-side connector and the gripping portion-side connector are connected by aligning an assembly direction of the substrate to the gripping portion with a connecting direction between the substrate-side connector and the gripping portion-side connector. Therefore, it is possible to improve the workability of the connecting operation of the substrate and the power supply wiring in the steering wheel.

What is claimed is:

1. A steering wheel comprising:
a gripping portion gripped by a driver; and
a light emitting device assembled to the gripping portion, wherein
the light emitting device includes a substrate having a light emitting element and having a substrate-side connector for relaying power supply wiring to the light emitting element, wherein the substrate-side connector is electrically connected to the light emitting element,
the gripping portion includes a gripping portion-side connector for relaying the power supply wiring, wherein the gripping portion-side connector is connected to the substrate-side connector,
a connecting direction between the substrate-side connector and the gripping portion-side connector aligns with an assembly direction of the substrate to the gripping portion.

2. The steering wheel according to claim 1, wherein
the connecting direction is parallel to a rotation axis of the steering wheel.

3. The steering wheel according to claim 1, wherein
the gripping portion further includes:
a harness as a part of the power supply wiring, wherein the harness has one end connected to the gripping portion-side connector; and
a fixing portion for fixing the gripping portion-side connector.

4. The steering wheel according to claim 1, wherein
the light emitting element is provided on a front surface of the substrate, and
the substrate-side connector is provided on a back surface of the substrate.

5. A method of manufacturing a steering wheel having a gripping portion gripped by a driver and a light emitting device assembled to the gripping portion, the method comprising:
preparing, as the light emitting device, a light emitting device that includes a substrate having a light emitting element and having a substrate-side connector for relaying power supply wiring to the light emitting element, the substrate-side connector being electrically connected to the light emitting element;
preparing, as the gripping portion, a gripping portion that includes a gripping portion-side connector for relaying the power supply wiring, the gripping portion-side connector being connected to the substrate-side connector; and
assembling the substrate to the gripping portion, wherein the substrate-side connector and the gripping portion-side connector are connected by aligning an assembly direction of the substrate to the gripping portion with a connecting direction between the substrate-side connector and the gripping portion-side connector.
